(19) United States
(12) Patent Application Publication
(10) Pub. No.: US 2015/0179424 A1
(43) Pub. Date: Jun. 25, 2015

(54) Efficient halogen tungsten bulb with high light efficiency

(71) Applicant: Wifeng Jia, QinHuangDao (CN)

(72) Inventor: Wifeng Jia, QinHuangDao (CN)

(21) Appl. No.: 14/365,526

(22) PCT Filed: Dec. 15, 2011
(86) PCT No.: PCT/CN2011/084061

§ 371 Date: Sep. 23, 2014

(51) Int. Cl. H01K 1/20; H01K 1/50; H01K 1/40; H01K 1/08

(52) U.S. Cl. CPC H01K 1/20; H01K 1/08; H01K 1/50; H01K 1/40

(57) ABSTRACT

A high luminous efficiency energy-saving halogen tungsten lamp includes a bulb shell, a molybdenum bracket, a tungsten wire, molybdenum strips and molybdenum wires. The molybdenum strips, the tungsten wire and the molybdenum bracket are packaged in the bulb shell, the bulb shell is filled with circulating gas, an upper end of each molybdenum strip is respectively connected with one molybdenum wire, an upper end of each molybdenum wire extends out of the bulb shell, a lower end of a first molybdenum strips is connected with an upper end of the molybdenum bracket, a lower end of the molybdenum bracket is connected with the tungsten wire, and an upper end of the tungsten wire is connected with a second molybdenum strip. The high luminous efficiency energy-saving halogen tungsten lamp adopts a single-filament and single-end structure, the size of the bulb shell is smaller, and it has only one cold end, so that the heat loss of the glass bulb shell and a filament can be reduced, the luminous efficiency can be maximized, visible light output is much more, and the service life is also prolonged.

### CROSS REFERENCE OF RELATED APPLICATION

This is a U.S. National Stage under 35 U.S.C 371 of the International Application PCT/CN2011/084061, filed Dec. 15,2011.

### BACKGROUND OF THE PRESENT INVENTION

1. Field of Invention

The present invention relates to a bulb, in particular to a high-luminous efficiency energy-saving halogen tungsten lamp.

2. Description of Related Arts

At present, a traditional halogen tungsten lamp adopts a double-end single-filament design or a single-end double-filament design; moreover, the filament length is longer than 10 mm. As a result, the luminous efficiency is low, and excessive energy is consumed, which has attracted the attention of various countries.

### SUMMARY OF THE PRESENT INVENTION

The present invention aims to solve the technical problems and provides a halogen tungsten lamp with high luminous efficiency, small heat loss and high energy efficiency.

In order to solve the technical problems, the present invention adopts the following technical scheme:

A high luminous efficiency energy-saving halogen tungsten lamp comprises a bulb shell, a molybdenum bracket, a tungsten wire, molybdenum strips and molybdenum wires, wherein the molybdenum strips, the tungsten wire and the molybdenum bracket are packaged in the bulb shell, the bulb shell is filled with circulating gas, an upper end of each molybdenum strip is respectively connected with one of the molybdenum wires, the upper end of each molybdenum wire extends out of the bulb shell. A lower end of a first molybdenum strip is connected with an upper end of the molybdenum bracket, a lower end of the molybdenum bracket is connected with the tungsten wire, and an upper end of the tungsten wire is connected with a second molybdenum strip.

In the high luminous efficiency energy-saving halogen tungsten lamp provided by the present invention, the tungsten wire is a straight spiral filament, and when a power of the lamp is set to be 29-70 W, a length of a spiral section thereof is 8-10 mm.

In the high luminous efficiency energy-saving halogen tungsten lamp provided by the present invention, the tungsten wire is used after following treatment: setting the tungsten wire in a magnetic field and keeping the tungsten wire in a horizontal state, then setting a 150V direct current on the tungsten wire for crystallization for about 10-15 seconds.

In the high luminous efficiency energy-saving halogen tungsten lamp provided by the present invention, the molybdenum bracket is L-shaped, an end of a transverse section of the molybdenum bracket bends backwards to form a bending part, and a lower end of the tungsten wire goes through the bending part and contacts with the molybdenum bracket.

In the high luminous efficiency energy-saving halogen tungsten lamp provided by the present invention, the circulating gas contains 10% of nitrogen ,90% of xenon or krypton or mixed gas of xenon or krypton (volume percentage), and further contains 100-250 ppm of dibromomethane and 125 ppm of PH₃.

In the high luminous efficiency energy-saving halogen tungsten lamp provided by the present invention, the upper end of the tungsten wire is connected with a tantalum plate by welding, and the tantalum plate is welded on the second molybdenum strip.

The high luminous efficiency energy-saving halogen tungsten lamp, provided by the present invention, adopts a single-end single-filament design, has a small sized bulb shell, and has only one cold end, so that the heat loss of the glass bulb shell and the filament can be reduced, the luminous efficiency can be maximized, the visible light output is much more, and the service life is also prolonged.

The high luminous efficiency energy-saving halogen tungsten lamp provided by the present invention is further described in combination with the following drawings.

### BRIEF DESCRIPTION OF THE DRAWINGS

FIG. 1 is a main view of a high luminous efficiency energy-saving halogen tungsten lamp according to a preferred embodiment of the present invention;

FIG. 2 is a left view of FIG. 1;

FIG. 3 is a schematic diagram of a connection structure of a tungsten wire and a molybdenum bracket according to the preferred embodiment of the present invention.

### DETAILED DESCRIPTION OF THE PREFERRED EMBODIMENT

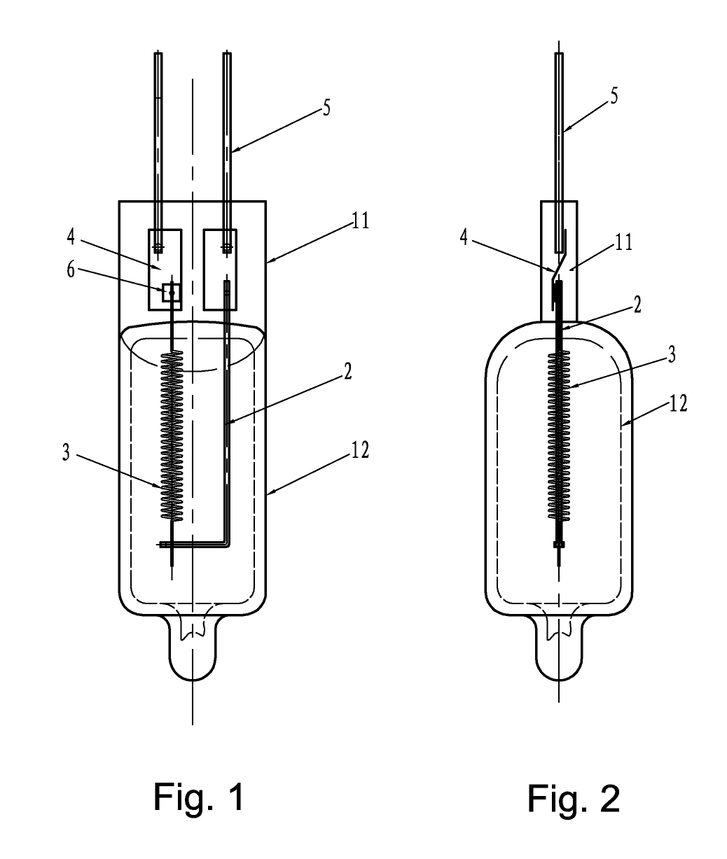

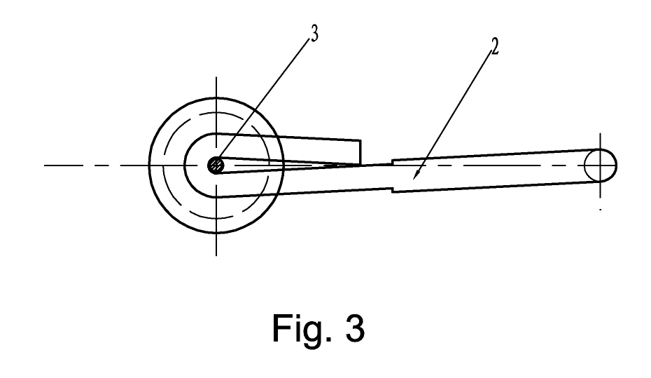

As shown in FIGS. 1 and 2, according to a preferred embodiment of the present invention, a high luminous efficiency energy-saving halogen tungsten lamp comprises a bulb shell, a molybdenum bracket 2, a tungsten wire 3, molybdenum strips 4, molybdenum wires 5 and a tantalum plate 6. The bulb shell comprises integrally molded upper shell 11 and lower bulb shell tube 12, the molybdenum strips 4 are packaged in the upper shell 11, the tungsten wire 3 and the molybdenum bracket 2 are packaged in the lower bulb shell tube 12, an upper end of each molybdenum strip 4 is respectively connected with one of the molybdenum wire 5, an upper end of each molybdenum wire 5 extends out of the upper shell 11, a lower end of a first the molybdenum strips 4 is welded with an upper end of the molybdenum bracket 2, the molybdenum bracket 2 is L-shaped, and as shown in FIG. 3, an end of a transverse section of the molybdenum bracket 2 bends backwards to form a bending part, a lower end of the tungsten wire 3 goes through the bending part and contacts with the molybdenum bracket 2, an upper end of the tungsten wire 3 is connected with the tantalum plate 6 by welding, and the tantalum plate 6 is welded on a second molybdenum strip 4. The tungsten wire 3 is a straight spiral filament, and when a power of the lamp is set to be 29-70 W, a length of a spiral section thereof is 8-10 mm.

The tungsten wire 3 is used after following treatment: setting the tungsten wire in a magnetic field and keeping the tungsten wire in a horizontal state, then setting a 150V direct current on the tungsten wire for crystallization for about 10-15 seconds.

The lower bulb shell tube 12 is filled with circulating gas, the circulating gas contains 10% of nitrogen, 90% of xenon or krypton or mixed gas of xenon or krypton (volume percentage), and further contains 100-250 ppm of dibromomethane and 125 ppm of PH₃, and specific contents of the circulating gas can be determined according to the power of a lamp. The table below shows preferred contents of all components in the circulating gas at different powers.

| | |
|---|---|
| 120V29W, 43W | 100~150 ppm CH₂Br₂ + 125 ppm PH₃ + |
| | 10% N₂ + 90% Xe |
| | 100~150 ppm CH₂Br₂ + 125 ppm PH₃ + |
| | 10% N₂ + 45% Xe + 45% Kr |
| | 100~150 ppm CH₂Br₂ + 125 ppm PH₃ + |
| | 10% N₂ + 90% Kr |
| 120V53W, 70W | 180~250 ppm CH₂Br₂ + 125 ppm PH₃ + |
| | 10% N₂ + 90% Xe |
| | 180~250 ppm CH₂Br₂ + 125 ppm PH₃ + |
| | 10% N₂ + 45% Xe + 45% Kr |
| | 180~250 ppm CH₂Br₂ + 125 ppm PH₃ + |
| | 10% N₂ + 90% Kr |

In the mixed gas of the xenon and the krypton in the circulating gas, any mixture ratio of the two can be adopted, and the specific ratio can be determined according to the requirement for the service life of the lamp and the requirement for the cost.

Compared with a traditional halogen tungsten lamp, the high luminous efficiency energy-saving halogen tungsten lamp provided by the present invention has the following advantages:

(1) A single-filament and single-end design is adopted; compared with two ends of the traditional tungsten lamp, the lamp provided by the present invention has a smaller bulb shell size, and has only one cold end, which reduces heat loss; moreover, the single-filament design is adopted, the tungsten wire is straight spiral filament, the filament is more compact, when the power is set 29-70 W, the length of the spiral section is 8-10 mm, an effective luminous body of the filament is shorter, which can maximize a luminous efficiency, improve the luminous efficiency by above 30%, enable the heat loss to be smaller, output more visible light, prolong the service life and meet the latest energy-saving and consumption-reducing requirements of various countries.

(2) The molybdenum bracket is L-shaped, the end of the transverse section of the molybdenum bracket bends backwards to form the bending part, the lower end of the tungsten wire goes through the bending part and contacts with the molybdenum bracket, and the molybdenum bracket is linked with the tungsten wire by adopting a half-surrounding way; and compared with a traditional way of tightly clamping the filament, the damages to the filament are avoided, the filament can be firmly fixed, the vibration resistance of the filament is also improved, and the excessive heat loss can also be avoided.

(3) The tungsten wire is used after following treatment: setting the tungsten wire in a magnetic field and keeping the tungsten wire in a horizontal state, then setting a 150V direct current on the tungsten wire for crystallization for about 10-15 seconds. After the treatment, the strength of the filament is improved, a short-circuit burnout phenomenon of the tungsten wire caused by droop is prevented, the service life of the filament is prolonged, the design temperature of the filament can be further increased, and the luminous efficiency is improved.

(4) The xenon or the krypton or the mixed gas of the two with high molecular weight, the nitrogen and a small amount of the dibromomethane and hydrogen phosphide are taken as the circulating gas, so that the filament is less prone to evaporation deposition, the temperature of the filament is increased, and the luminous efficiency is improved.

Although the present invention has been described with reference to the preferred embodiments thereof, it will be understood that the above description should not be construed as limiting the scope of the present invention. Various substitutions and modifications may be made by those skilled in the art without departing from the spirit of the present invention, and all such substitutions and modifications are intended to be embraced within the scope of the present invention as defined in the appended claims.

### INDUSTRIAL APPLICABILITY

The high-luminous efficiency energy-saving type halogen tungsten lamp provided by the present invention can be used for occasions where lamps are required in every industry, and can meet the latest energy-saving and consumption-reducing requirements of various countries due to high luminous efficiency and small heat loss.

What is claimed is:

1. A high luminous efficiency energy-saving halogen tungsten lamp, comprising a bulb shell, a molybdenum bracket, a tungsten wire, molybdenum strips and molybdenum wires, wherein the molybdenum strips, the tungsten wire and the molybdenum bracket are packaged in the bulb shell, the bulb shell is filled with circulating gas, an upper end of each molybdenum strip is respectively connected with one of the molybdenum wires, an upper end of each molybdenum wire extends out of the bulb shell; and
wherein a lower end of a first molybdenum strip is connected with an upper end of the molybdenum bracket, a lower end of the molybdenum bracket is connected with the tungsten wire, and an upper end of the tungsten wire is connected with a second molybdenum strip.

2. The high luminous efficiency energy-saving halogen tungsten lamp according to claim 1, wherein the tungsten wire is set to be a straight spiral filament, and when a power of the lamp is set to be 29-70 W, a length of a spiral section thereof is 8-10 mm.

3. The high luminous efficiency energy-saving halogen tungsten lamp according to claim 2, wherein the tungsten wire is used after following treatment: setting the tungsten wire in a magnetic field and keeping the tungsten wire in a horizontal state, then setting a 150V direct current on the tungsten wire for crystallization for 10-15 seconds.

4. The high luminous efficiency energy-saving halogen tungsten lamp according to claim 3, wherein the molybdenum bracket is L-shaped, an end of a transverse section of the molybdenum bracket bends backwards to form a bending part, and a lower end of the tungsten wire goes through the bending part and contacts with the molybdenum bracket.

5. The high luminous efficiency energy-saving halogen tungsten lamp according to claim 4, wherein the circulating gas contains 10% of nitrogen, 90% of xenon or krypton or mixed gas of xenon or krypton (volume percentage), and further contains 100-250 ppm of dibromomethane and 125 ppm of PH₃.

6. The high luminous efficiency energy-saving halogen tungsten lamp according to claim 5, wherein an upper end of the tungsten wire is connected with a tantalum plate by welding, and the tantalum plate is welded on the second molybdenum strip.
